(19) United States
(12) Patent Application Publication
(10) Pub. No.: US 2009/0235668 A1
(43) Pub. Date: Sep. 24, 2009

(54) Insulator bushing for combustion liner

(75) Inventors: Thomas Edward Johnson, Greer, SC (US); Marcus B. Huffman, Greenville, SC (US)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 12/076,385

(22) Filed: Mar. 18, 2008

(51) Int. Cl. F02C 7/12; F02C 1/00

(52) U.S. Cl. 60/782; 60/752; 60/39.83

(57) ABSTRACT

A combustor for a turbine including: a combustor liner, a first flow sleeve surrounding the combustor liner to define a first flow annulus, the first flow sleeve having cooling holes for directing compressor discharge air as cooling air into the first flow annulus, a transition piece body connected to the combustor liner to carry hot combustion gases to the turbine; a second flow sleeve surrounding the transition piece body, the second flow sleeve having cooling holes for directing compressor discharge air as cooling air into a second flow annulus between the second flow sleeve and the transition piece body; at least one dilution hole in the combustor liner for flowing compressor air into a combustion chamber defined by the combustor liner; and a bushing seated in at least one of the cooling or dilution holes and secured with respect thereto for defining a flow passage for compressor discharge air through the hole.

### BACKGROUND OF THE INVENTION

This invention relates to internal cooling within a gas turbine engine and, more particularly, to an assembly and method for preventing large thermal gradients from developing in the transition piece or liner wall.

Traditional gas turbine combustors use diffusion (i.e., non-premixed) combustion in which fuel and air enter the combustion chamber separately. The process of mixing and burning produces flame temperatures exceeding 3900° F. Since conventional combustors and/or transition pieces having liners are generally capable of withstanding a maximum temperature on the order of only about 1500° F. for about ten thousand hours (10,000 hrs), steps to protect the combustor and/or transition piece must be taken. This has typically been done by film-cooling which involves introducing relatively cool compressor air into a plenum formed by the combustor liner surrounding the outside of the combustor. In this prior arrangement, the air from the plenum passes through louvers in the combustor liner and then passes as a film over the inner surface of the liner, thereby maintaining combustor liner integrity.

Because diatomic nitrogen rapidly disassociates at temperatures exceeding about 3000° F. (about 1650° C.), the high temperatures of diffusion combustion result in relatively large NOx emissions. One approach to reducing NOx emissions has been to premix the maximum possible amount of compressor air with fuel. The resulting lean premixed combustion produces cooler flame temperatures and thus lower NOx emissions. Although lean premixed combustion is cooler than diffusion combustion, the flame temperature is still too hot for prior conventional combustor components to withstand.

Furthermore, because the advanced combustors premix the maximum possible amount of air with the fuel for NOx reduction, little or no cooling air is available, making film-cooling of the combustor liner and transition piece premature at best. Nevertheless, combustor liners require active cooling to maintain material temperatures below limits. In dry low NOx (DLN) emission systems, this cooling can only be supplied as cold side convection. Such cooling must be performed within the requirements of thermal gradients and pressure loss. Thus, means such as thermal barrier coatings in conjunction with “backside” cooling have been considered to protect the combustor liner and transition piece from destruction by such high heat. Backside cooling involved passing the compressor discharge air over the outer surface of the transition piece and combustor liner prior to premixing the air with the fuel.

The conventional method of adding cooling or dilution air into a combustor is simply to drill a hole through the wall. When a combustion or dilution hole is formed in a combustion liner or transition piece, relatively cold air will rush through the hole and cool the inner surface of the hole. Moving to areas away from the hole, the temperature of the liner material increases to some substantially higher value. Due to the resulting differential thermal expansions, strains and stresses develop in the liner material and may be high enough to cause low cycle fatigue cracking in the liners and transition pieces.

### BRIEF DESCRIPTION OF THE INVENTION

The invention provides a bushing inserted into a combustion cooling or dilution hole of a combustion liner or transition piece to act as an insulator that prevents large thermal gradients from developing in the transition piece or liner wall.

Thus the invention may be embodied in a combustor for a turbine comprising: a combustor liner; a first flow sleeve surrounding said combustor liner with a first flow annulus therebetween, said first flow sleeve having a plurality of cooling holes formed about a circumference thereof for directing compressor discharge air as cooling air into said first flow annulus; a transition piece body connected to said combustor liner, said transition piece body being adapted to carry hot combustion gases to the turbine; a second flow sleeve surrounding said transition piece body, said second flow sleeve having a second plurality of cooling holes for directing compressor discharge air as cooling air into a second flow annulus between the second flow sleeve and the transition piece body, said first flow annulus connecting to said second flow annulus; at least one dilution hole in said combustor liner for flowing compressor air into a combustion chamber defined by said combustor liner; and a bushing seated in at least one of said cooling or dilution holes and secured with respect thereto so as to extend through said hole from a radially inner side to a radially outer side thereof for defining a flow passage for compressor discharge air through said hole.

The invention may also be embodied in a turbine engine comprising: a combustion section; an air discharge section downstream of the combustion section; a transition region between the combustion and air discharge sections; a combustor liner defining a portion of the combustion section and transition region; a first flow sleeve surrounding said combustor liner with a first flow annulus therebetween, said first flow sleeve having a plurality of rows of cooling holes formed about a circumference of said first flow sleeve for directing compressor discharge air as cooling air into said first flow annulus; a transition piece body connected to at least one of said combustor liner and said first flow sleeve, said transition piece body being adapted to carry hot combustion gases to a stage of the turbine corresponding to the air discharge section; a second flow sleeve surrounding said transition piece body, said second flow sleeve having a second plurality of rows of cooling holes for directing compressor discharge air as cooling air into a second flow annulus between the second flow sleeve and the transition piece body, said first flow annulus connecting to said second flow annulus; at least one dilution hole in said combustor liner for flowing compressor air into a combustion chamber defined by said combustor liner; and a bushing seated in at least one of said cooling or dilution holes and secured with respect thereto so as to extend through said hole from a radially inner side to a radially outer side thereof for defining a flow passage for compressor discharge air through said hole.

The invention may also be embodied in a method of cooling a transition region between a combustion section comprising a combustor liner and a first flow sleeve surrounding said combustor liner with a first flow annulus therebetween, said first flow sleeve having a plurality of cooling holes formed about a circumference thereof for directing compressor discharge air as cooling air into said first flow annulus, and a transition region comprising a transition piece body connected to said combustor liner, said transition piece body being adapted to carry hot combustion gases to a turbine, a second flow sleeve surrounding said transition piece body, said second flow sleeve having a second plurality of cooling holes for directing compressor discharge air as cooling air into a second flow annulus between the second flow sleeve and the transition piece body, said first flow annulus connecting to said second flow annulus; at least one dilution hole in said combustor liner for flowing compressor air into a combustion chamber defined by said combustor liner; the method comprising: seating a bushing in at least one of said cooling or dilution holes; securing the bushing with respect to the hole so as to extend through said hole from a radially inner side to a radially outer side thereof for defining a flow passage for compressor discharge air through said hole; and flowing compressor discharge air through said hole.

### BRIEF DESCRIPTION OF THE DRAWINGS

These and other objects and advantages of this invention, will be more completely understood and appreciated by careful study of the following more detailed description of the presently preferred exemplary embodiments of the invention taken in conjunction with the accompanying drawings, in which:

FIG. 1 is a partial schematic illustration of a gas turbine combustor section; and

FIG. 2 is a close-up view of a cross-section through a combustion liner or transition piece illustrating an insulating bushing provided according to an example embodiment of the invention.

### DETAILED DESCRIPTION OF THE INVENTION

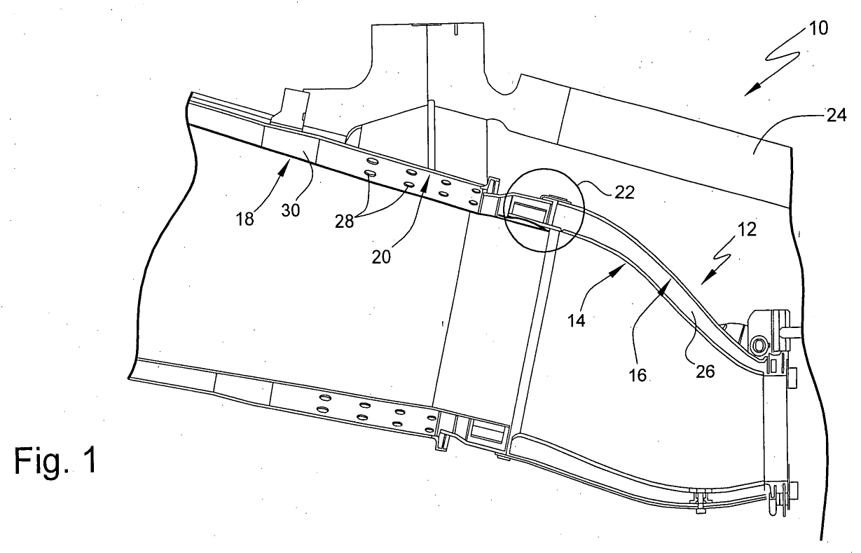

FIG. 1 schematically depicts the aft end of a combustor in cross-section. As can be seen, in this example, the transition piece 12 includes a radially inner transition piece body 14 and a radially outer transition piece impingement sleeve 16 spaced from the transition piece body 14. Upstream thereof is the combustion liner 18 and the combustor flow sleeve 20 defined in surrounding relation thereto. The encircled region is the transition piece forward sleeve assembly 22.

Flow from the gas turbine compressor (not shown) enters into a case 24. About 50% of the compressor discharge air passes through apertures (not shown in detail) formed along and about the transition piece impingement sleeve 16 for flow in an annular region or annulus 26 between the transition piece body 14 and the radially outer transition piece impingement sleeve 16. The remaining approximately 50% of the compressor discharge flow passes into flow sleeve holes 28 of the upstream combustion liner cooling sleeve 20 and into an annulus 30 between the cooling sleeve 20 and the liner 18 and eventually mixes with the air from the downstream annulus 26. A portion of the combined air eventually passes through dilution holes of the combustion liner or transition piece and mixes with the burning gasses in the combustion chamber.

The present invention relates to the provision of bushings inserted into combustion cooling or dilution holes of a combustion liner or transition piece. A bushing provided according to the invention acts as an insulator that prevents large thermal gradients from developing in the transition piece or liner wall.

As noted above, when a hole is formed in the combustion liner, relatively cool air rushes through this hole. This results in a relatively cool inner diameter of the hole due to the air rushing through the hole. This cool air cools the metal, which in turn causes a thermal mismatch with the remaining hot metal surrounding the hole. The thermal mismatch results in thermal fatigue and low cycle fatigue cracking in the liners and transition pieces. The bushing provided according to an example embodiment of the invention shields the inside wall of the hole in the liner material from the cool air, thus preventing the large thermal gradients and subsequent cracking problems of the conventional structure.

In an example embodiment of the invention, the bushing is held in the liner using a trapping method. In this regard, if the bushing is fastened via welding, there is a risk of cracking or failure in a short time due to the large thermal gradients in this area.

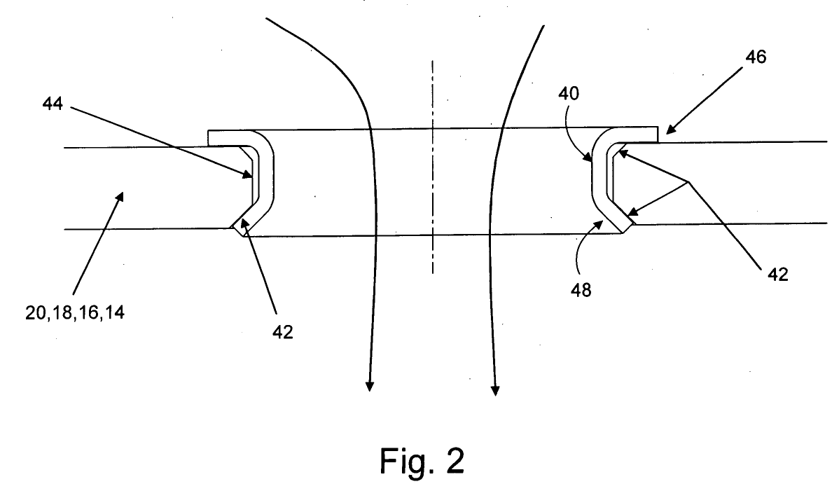

Referring to FIG. 2, FIG. 2 is a close-up view of a cross-section through a combustion liner 18 or transition piece 14 incorporating an insulating bushing embodying the invention. As illustrated, the longitudinal ends of the bushing are flared to tightly fill the gap between the metal material at one point of contact with the bushing. In the illustrated example, chamfer features 42 are formed in the edges of the holes in the liner. As a consequence, an insulating air gap 44 is formed between the flared ends which respectively define retention lip 46 from the cold side of the liner and a retention lip 48 on the hot side of the liner. The air gap 44 provides a very high thermal resistance to heat transfer between the cold bushing flow path and the hot liner hole diameter. As will be appreciated, the bushing's outer retention lip 46 prevents the bushing from falling into the combustor and provides one surface of the insulating cavity 44. The bushing's inner retention lip 48 provides the radial inner boundary for the insulating cavity 44 as well as the surface which centers the bushing with respect to the hole. As noted above, the bushing is crimped or flared in such a way that the lip 48 is forced against the radially inner chamfer 42 of the hole in the liner. This centers the bushing, prevents leakage between the bushing and the liner and prevents motion which could cause wear. It should also be noted that in an example embodiment, the bushing is saddle shaped after being crimped or flared with respect to the hole because of the curvature of the liner. Due to this saddle shape, more specifically the saddle shape of the retainer lips of the bushing, the bushing will not be able to rotate within the hole with respect to the liner because the lateral sides of the retainer lips dip with respect to the portions of the retainer lips that are aligned with the long axis of the liner. However, a weld, staking or pin may be employed on one side of the outer retention lip 46 to further ensure that there is no movement between the bushing 40 and the liner. The chamfer could be incorporated on the opposite side from what is shown. This may be less durable, but may have a better flow coefficient.

The material of the bushing may be such that it has high thermal expansion relative to the liner material which would force it to grow tighter in a radial direction as the system heats up. This, however, is not a requirement as expansion in the thickness direction will result in a favorable thermal match and force the system to get tighter. The bushings can be fabricated via machining, forming or casting. As a further option, the bushings may be cooled if needed, e.g., if they experience any oxidation, etc. This could be accomplished by adding purge holes or slots in the liner or holes or slots in the bushing. This would vent the insulating cavity yet keep the heat transfer or cooling effect to the liner very low so large thermal gradients will not develop.

Although a flaring has been illustrated for securing the bushing with respect to the hole, other retention methods may be used such as employing a threaded fastener on the cold, radially outer side of the sleeve. Such a fastener however would be more costly than the flaring of the illustrated embodiment. A threaded fastener would also lack a centering method to ensure an appropriate air gap, as provided by the flaring method described above.

The invention can be employed in any combustion liner arrangement where holes are needed and high gradients are anticipated. In addition to its insulating ability, the bushing according to an example embodiment can solve several other problems. For example, it can be used to size a combustion dilution hole in a more permanent manner than conventionally provided welded in dilution hole washers or plugs. In addition to providing a higher durability method of sizing a dilution hole, the bushing of the invention would also be a faster and less expensive sizing method to implement. The bushing may also be used to retrofit and re-size existing holes. More specifically, existing holes that have experienced distress such as cracking, oxidation and the like, can be machined out and a suitable bushing inserted and secured by flaring the respective longitudinal end(s) to thus restore the liner or transition piece's hole to its original flow-through diameter.

Further alternative embodiments to the disclosed design include providing a bushing that is coated (TBC or hard-face) and/or shaping the bushing other than round to tailor the air going into the combustor. For example, the holes formed by the bushing could have a shape other than round, such as a race track shape or elliptical. This could be used to get better penetration of the air into the combustor, if needed. As a further alternative, the bushing may be configured to inject the air into the combustor at an angle other than normal or 90 degrees from the wall, for instance in a downstream direction.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A combustor for a turbine comprising:
a combustor liner;
a first flow sleeve surrounding said combustor liner with a first flow annulus therebetween, said first flow sleeve having a plurality of cooling holes formed about a circumference thereof for directing compressor discharge air as cooling air into said first flow annulus;
a transition piece body connected to said combustor liner, said transition piece body being adapted to carry hot combustion gases to the turbine;
a second flow sleeve surrounding said transition piece body, said second flow sleeve having a second plurality of cooling holes for directing compressor discharge air as cooling air into a second flow annulus between the second flow sleeve and the transition piece body, said first flow annulus connecting to said second flow annulus;
at least one dilution hole in said combustor liner for flowing compressor air into a combustion chamber defined by said combustor liner; and
a bushing seated in at least one of said cooling or dilution holes and secured with respect thereto so as to extend through said hole from a radially inner side to a radially outer side thereof for defining a flow passage for compressor discharge air through said hole.

2. A combustor as in claim 1, wherein an insulating air gap is defined at least part circumferentially of said bushing between said bushing and an inner diameter of said hole.

3. A combustor as in claim 1, wherein said bushing is secured with respect to said hole by flaring at least one longitudinal end thereof to define a retention lip.

4. A combustor as in claim 1, wherein a chamfer is formed about at least one of a radially inner or radially outer edge of the hole.

5. A combustor as in claim 1, wherein the bushing is generally circular in transverse cross-section.

6. A combustor as in claim 1, wherein a material of the bushing has a higher thermal expansion coefficient than a material of the combustion liner.

7. A combustor as in claim 1, wherein the bushing is flared at each longitudinal end to center the bushing and define radially inner and outer boundaries for an insulating air gap defined between the bushing and the liner material.

8. A turbine engine comprising:
a combustion section; an air discharge section downstream of the combustion section;
a transition region between the combustion and air discharge sections;
a combustor liner defining a portion of the combustion section and transition region;
a first flow sleeve surrounding said combustor liner with a first flow annulus therebetween, said first flow sleeve having a plurality of rows of cooling holes formed about a circumference of said first flow sleeve for directing compressor discharge air as cooling air into said first flow annulus;
a transition piece body connected to at least one of said combustor liner and said first flow sleeve, said transition piece body being adapted to carry hot combustion gases to a stage of the turbine corresponding to the air discharge section;
a second flow sleeve surrounding said transition piece body, said second flow sleeve having a second plurality of rows of cooling holes for directing compressor discharge air as cooling air into a second flow annulus between the second flow sleeve and the transition piece body, said first flow annulus connecting to said second flow annulus;
at least one dilution hole in said combustor liner for flowing compressor air into a combustion chamber defined by said combustor liner; and
a bushing seated in at least one of said cooling or dilution holes and secured with respect thereto so as to extend through said hole from a radially inner side to a radially outer side thereof for defining a flow passage for compressor discharge air through said hole.

9. A turbine engine as in claim 8, wherein an insulating air gap is defined at least part circumferentially of said bushing between said bushing and an inner diameter of said hole.

10. A turbine engine as in claim 8, wherein said bushing is secured with respect to said hole by flaring at least one longitudinal end thereof to define a retention lip.

11. A turbine engine as in claim 8, wherein a chamfer is formed about at least one of a radially inner or radially outer edge of the hole.

12. A turbine engine as in claim 8, wherein the bushing is generally circular in transverse cross-section.

13. A turbine engine as in claim 8, wherein a material of the bushing has a higher thermal expansion coefficient than a material of the combustion liner.

14. A turbine engine as in claim 8, wherein the bushing is flared at each longitudinal end to center the bushing and define radially inner and outer boundaries for an insulating air gap defined between the bushing and the liner material.

15. A method of cooling a transition region between a combustion section comprising a combustor liner and a first flow sleeve surrounding said combustor liner with a first flow annulus therebetween, said first flow sleeve having a plurality of cooling holes formed about a circumference thereof for directing compressor discharge air as cooling air into said first flow annulus, and a transition region comprising a transition piece body connected to said combustor liner, said transition piece body being adapted to carry hot combustion gases to a turbine, a second flow sleeve surrounding said transition piece body, said second flow sleeve having a second plurality of cooling holes for directing compressor discharge air as cooling air into a second flow annulus between the second flow sleeve and the transition piece body, said first flow annulus connecting to said second flow annulus; at least one dilution hole in said combustor liner for flowing compressor air into a combustion chamber defined by said combustor liner;
the method comprising:
seating a bushing in at least one of said cooling or dilution holes;
securing the bushing with respect to the hole so as to extend through said hole from a radially inner side to a radially outer side thereof for defining a flow passage for compressor discharge air through said hole; and
flowing compressor discharge air through said hole.

16. A method as in claim 15, wherein at least one longitudinal end of the bushing is crimped or flared to form a retention lip for locking the bushing in place.

17. A method as in claim 15, wherein the hole is chamfered about at least one of the radially inner and radilly outer edges thereof.

18. A method as in claim 17, wherein the bushing is crimped or flared in such a manner that a retention lip is formed that is forced against a radially inner chamfer of the hole in the liner.
